(19) United States
(12) Patent Application Publication
(10) Pub. No.: US 2013/0300957 A1
(43) Pub. Date: Nov. 14, 2013

(54) DISPLAY UNIT, BARRIER DEVICE, AND ELECTRONIC APPARATUS

(71) Applicant: SONY CORPORATION, Tokyo (JP)

(72) Inventor: Yuichi Inoue, Kanagawa (JP)

(73) Assignee: Sony Corporation, Tokyo (JP)

(21) Appl. No.: 13/875,875

(22) Filed: May 2, 2013

(30) Foreign Application Priority Data
May 9, 2012 (JP) 2012-107894

(51) Int. Cl. G02F 1/1335

(52) U.S. Cl. CPC G02F 1/1335
USPC 349/15; 349/193

(57) ABSTRACT

A display unit includes: a display section displaying an image; and a barrier section including a plurality of liquid crystal barriers, the light crystal barriers allowing light to pass therethrough and blocking the light, and extending in a first direction and being arranged side by side in a second direction orthogonal to the first direction. The barrier section includes a liquid crystal layer, first electrodes disposed in regions corresponding to the respective liquid crystal barriers, and a second electrode disposed between the first electrodes and the liquid crystal layer and disposed to face and be common to the first electrodes. The second electrode includes a plurality of slit array regions arranged side by side in the second direction, and each of the slit array regions includes a plurality of slits provided side by side, the slits in any one of the slit array regions extending in a same direction.

### BACKGROUND

The present disclosure relates to a display unit enabling stereoscopic display, a barrier device used in such a display unit, and an electronic apparatus including such a display unit.

In recent years, display units enabling stereoscopic display have been attracting attention. In stereoscopic display, a left-eye image and a right-eye image having parallax therebetween (having different perspectives) are displayed, and when a viewer sees the left-eye image and the right-eye image with his left eye and his right eyes, respectively, the viewer perceives the images as a stereoscopic image with depth. Moreover, display units capable of providing a more natural stereoscopic image to a viewer through displaying three or more images having parallax therebetween have been also developed.

Such display units are broadly classified into display units which use special glasses and display units which use no special glasses. Viewers find wearing the special glasses inconvenient; therefore, the display units which use no special glasses are desired. Examples of the display units which use no special glasses include a parallax barrier type and a lenticular lens type. In these types, a plurality of images (perspective images) having parallax therebetween are displayed together, and a viewer sees images different depending on a relative positional relationship (angle) between a display unit and the viewer. For example, in Japanese Unexamined Patent Application Publication No. H03-119889, a parallax barrier type display unit using a liquid crystal device as a barrier is disclosed.

### SUMMARY

In general, high image quality is desired in display units, and display units enabling stereoscopic display are also expected to achieve high image quality.

It is desirable to provide a display unit, a barrier device, and an electronic apparatus which are capable of enhancing image quality.

According to an embodiment of the disclosure, there is provided a display unit including: a display section displaying an image; and a barrier section including a plurality of liquid crystal barriers, the light crystal barriers allowing light to pass therethrough and blocking the light, and extending in a first direction and being arranged side by side in a second direction that is orthogonal to the first direction, in which the barrier section includes a liquid crystal layer, first electrodes disposed in regions corresponding to the respective liquid crystal barriers, and a second electrode disposed between the first electrodes and the liquid crystal layer and disposed to face and be common to the first electrodes, the second electrode includes a plurality of slit array regions arranged side by side in the second direction, and each of the slit array regions includes a plurality of slits provided side by side, the slits in any one of the slit array regions extending in a same direction.

According to an embodiment of the disclosure, there is provided a barrier device including: a barrier section including a plurality of liquid crystal barriers, the liquid crystal barriers allowing light to pass therethrough and blocking the light, and extending in a first direction and being arranged side by side in a second direction that is orthogonal to the first direction, in which the barrier section includes a liquid crystal layer, first electrodes disposed in regions corresponding to the respective liquid crystal barriers, and a second electrode disposed between the first electrodes and the liquid crystal layer and disposed to face and be common to the first electrodes, the second electrode includes a plurality of slit array regions arranged side by side in the second direction, and each of the slit array regions includes a plurality of slits provided side by side, the slits in any one of the slit array regions extending in a same direction.

According to an embodiment of the disclosure, there is provided an electronic apparatus provided with a display unit and a control section which performs operation control with use of the display unit, the display unit including: a display section displaying an image; and a barrier section including a plurality of liquid crystal barriers, the light crystal barriers allowing light to pass therethrough and blocking the light, and extending in a first direction and being arranged side by side in a second direction that is orthogonal to the first direction, in which the barrier section includes a liquid crystal layer, first electrodes disposed in regions corresponding to the respective liquid crystal barriers, and a second electrode disposed between the first electrodes and the liquid crystal layer and disposed to face and be common to the first electrodes, the second electrode includes a plurality of slit array regions arranged side by side in the second direction, and each of the slit array regions includes a plurality of slits provided side by side, the slits in any one of the slit array regions extending in a same direction. The electronic apparatus according to the embodiment of the disclosure may include, for example, a television, a digital camera, a personal computer, a video camera, or a portable terminal device such as a cellular phone.

In the display unit, the barrier device, and the electronic apparatus according to the embodiments of the disclosure, the second electrode disposed to face and be common to the plurality of first electrodes is formed between the plurality of first electrodes and the liquid crystal layer. In the second electrode, the plurality of slit array regions are arranged side by side in the second direction.

In the display unit, the barrier device, and the electronic apparatus according to the embodiments of the disclosure, the plurality of slit array regions are arranged side by side in the second direction in the second electrode formed between the plurality of first electrodes and the liquid crystal layer; therefore, image quality is allowed to be enhanced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a block diagram illustrating a configuration example of a stereoscopic display unit according to an embodiment of the disclosure.

FIGS. 2A and 2B are explanatory diagrams illustrating a configuration example of the stereoscopic display unit illustrated in FIG. 1.

FIG. 3 is a block diagram illustrating a configuration example of a display drive section illustrated in FIG. 1.

FIGS. 4A and 4B are explanatory diagrams illustrating a configuration example of the display section illustrated in FIG. 1.

FIG. 5 is a circuit diagram illustrating a configuration example of a sub-pixel illustrated in FIGS. 4A and 4B.

FIGS. 6A and 6B are explanatory diagrams illustrating a configuration example of a barrier section illustrated in FIG. 1.

FIGS. 7A and 7B are plan views illustrating configuration examples of transparent electrode layers illustrated in FIGS. 6A and 6B.

FIG. 8 is an explanatory diagram illustrating a group configuration example of opening-closing sections illustrated in FIGS. 6A and 6B.

FIGS. 9A to 9D are schematic views illustrating a relationship between the display section and the barrier section illustrated in FIG. 1.

FIG. 10 is a schematic view illustrating an operation example of the stereoscopic display unit illustrated in FIG. 1.

FIG. 11 is an explanatory diagram illustrating a boundary between slit array regions illustrated in FIGS. 7A and 7B.

FIG. 12 is an explanatory diagram illustrating an interval between the slit array regions illustrated in FIGS. 7A and 7B.

FIG. 13 is a sectional view illustrating configuration examples of transparent electrode layers according to a comparative example.

FIG. 14 is a plan view illustrating a configuration example of the transparent electrode layer illustrated in FIG. 13.

FIG. 15 is an explanatory diagram illustrating an interval between slit array regions illustrated in FIG. 13.

FIG. 16 is a plan view illustrating a configuration example of a transparent electrode layer according to Comparative Example 2.

FIGS. 17A and 17B are explanatory diagrams for describing moire in a stereoscopic display unit according to Comparative Example 2.

FIGS. 18A and 18B are plan views illustrating configuration examples of transparent electrode layers according to a modification of the embodiment.

FIG. 19 is a plan view illustrating a configuration example of a transparent electrode layer according to another modification of the embodiment.

FIG. 20 is a plan view illustrating a configuration example of a transparent electrode layer according to still another modification of the embodiment.

FIG. 21 is a perspective view illustrating an appearance of a television to which the stereoscopic display unit according to the embodiment is applied.

FIGS. 22A and 22B are explanatory diagrams illustrating a configuration example of a stereoscopic display unit according to a modification.

FIG. 23 is a schematic view illustrating an operation example of the stereoscopic display unit illustrated in FIGS. 22A and 22B.

### DETAILED DESCRIPTION

Some embodiments of the present disclosure will be described in detail below referring to the accompanying drawings. It is to be noted that description will be given in the following order.

1. Embodiment

2. Application Examples

### 1. EMBODIMENT

### Configuration Example

### Entire Configuration Example

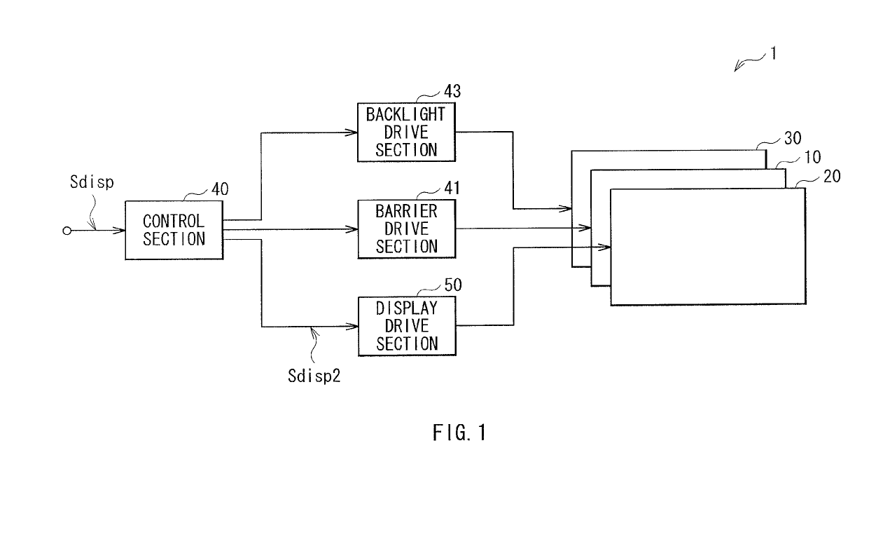

FIG. 1 illustrates a configuration example of a stereoscopic display unit 1 according to an embodiment. The stereoscopic display unit 1 is a parallax barrier type display unit using a liquid crystal barrier. It is to be noted that a displaying method according to an embodiment of the disclosure is embodied by the present embodiment, and will be also described together. The stereoscopic display unit 1 includes a control section 40, a backlight drive section 43, a backlight 30, a barrier drive section 41, a barrier section 10, a display drive section 50, and a display section 20.

The control section 40 is a circuit which supplies a control signal to each of the backlight drive section 43, the barrier drive section 41, and the display drive section 50, based on an image signal Sdisp externally supplied thereto, and thereby controls these sections to operate in synchronization with one another. More specifically, the control section 40 supplies a backlight control signal, a barrier control signal, and an image signal Sdisp2 which is generated based on the image signal Sdisp to the backlight drive section 43, the barrier drive section 41, and the display drive section 50, respectively. In this case, the image signal Sdisp2 is an image signal S2D including one perspective image when the stereoscopic display unit 1 performs normal display (two-dimensional display), and is an image signal S3D including a plurality of (eight in this example) perspective images when the stereoscopic display unit 1 performs stereoscopic display, as will be described later.

The backlight drive section 43 drives the backlight 30 based on the backlight control signal supplied from the control section 40. The backlight 30 has a function of emitting light toward the barrier section 10 and the display section 20 by surface emission. The backlight 30 may be configured of, for example, LEDs (Light Emitting Diodes) or CCFLs (Cold Cathode Fluorescent Lamps).

The barrier drive section 41 drives the barrier section 10 based on the barrier control signal supplied from the control section 40. The barrier section 10 allows light incident thereon to pass therethrough (an open operation) or blocks the light incident thereon (a close operation), and the barrier section 10 includes a plurality of opening-closing sections 11 and 12 (which will be described later) formed with use of a liquid crystal.

The display drive section 50 drives the display section 20 based on the image signal Sdisp2 supplied from the control section 40. In this example, the display section 20 is a liquid crystal display section, and drives liquid crystal display elements to modulate light incident thereon, and thereby performs display.

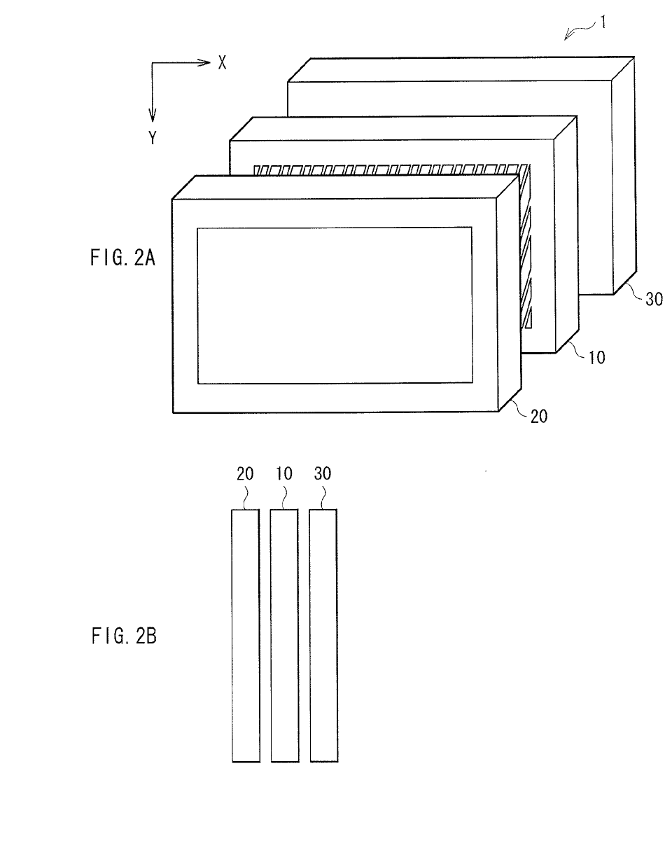

FIGS. 2A and 2B illustrate a configuration example of a main part of the stereoscopic display unit 1. FIG. 2A illustrates an exploded perspective configuration of the stereoscopic display unit 1, and FIG. 2B illustrates a side view of the stereoscopic display unit 1. As illustrated in FIGS. 2A and 2B, in the stereoscopic display unit 1, the backlight 30, the barrier section 10, and the display section 20 are arranged in this order. In other words, light emitted from the backlight 30 reaches a viewer through the barrier section 10 and the display section 20.

### (Display Drive Section 50 and Display Section 20)

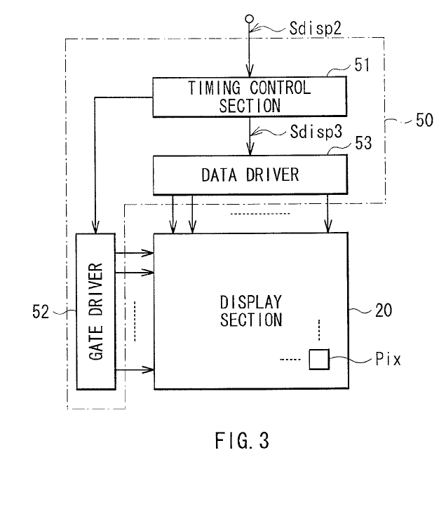

FIG. 3 illustrates an example of a block diagram of the display drive section 50. The display drive section 50 includes a timing control section 51, a gate driver 52, and a data driver 53. The timing control section 51 controls drive timings of the gate driver 52 and the data driver 53, and generates an image signal Sdisp3 based on the image signal Sdisp2 supplied from the control section 40, and then supplies the image signal Sdisp3 to the data driver 53. The gate driver 52 sequentially selects pixels Pix in the display section 20 from one row to another in response to timing control by the timing control section 51 to line-sequentially scan the pixels Pix. The data driver 53 supplies a pixel signal based on the image signal Sdisp3 to each of the pixels Pix in the display section 20. More specifically, the data driver 53 performs D/A (digital-to-analog) conversion based on the image signal Sdisp3 to generate a pixel signal which is an analog signal, and then supplies the pixel signal to each of the pixels Pix.

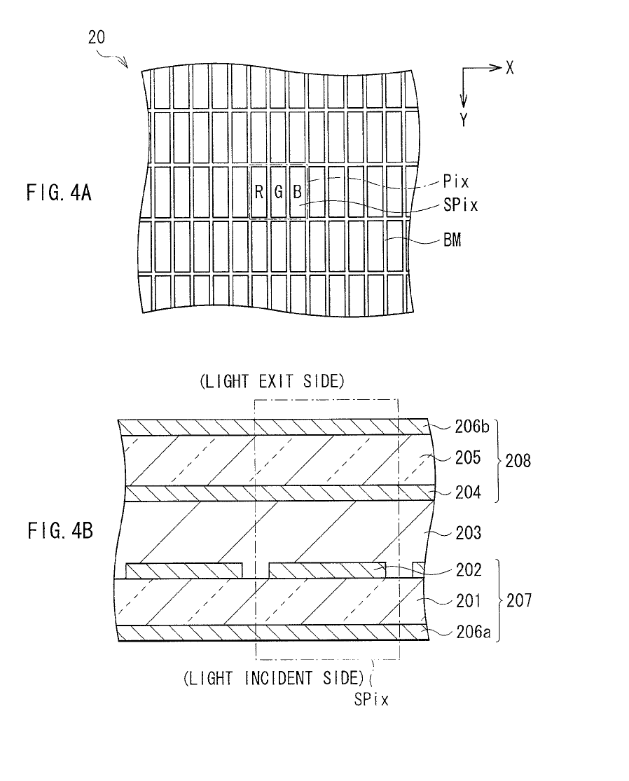

FIGS. 4A and 4B illustrate a configuration example of the display section 20. FIG. 4A illustrates an arrangement of the pixels Pix, and FIG. 4B illustrates a sectional configuration of the display section 20.

As illustrated in FIG. 4A, the pixels Pix are arranged in a matrix form in the display section 20. Each of the pixels Pix includes three sub-pixels SPix corresponding to red (R), green (G), and blue (B). A so-called black matrix BM is formed between the sub-pixels SPix to block light incident thereon. Thus, in the display section 20, mixture of red (R), green (G), and blue (B) is less likely to occur.

As illustrated in FIG. 4B, the display section 20 is configured through sealing a liquid crystal layer 203 between a drive substrate 207 and a counter substrate 208. The drive substrate 207 includes a transparent substrate 201, pixel electrodes 202, and a polarizing plate 206a. The transparent substrate 201 includes a pixel drive circuit (not illustrated) including a TFT element, and each of the pixel electrodes 202 is disposed corresponding to each of the sub-pixels SPix on the transparent substrate 201. Then, the polarizing plate 206a is bonded to a surface of the transparent substrate 201 opposite to a surface where the pixel electrodes 202 are disposed of the transparent substrate 201. The counter substrate 208 includes a transparent substrate 205, a counter electrode 204, and a polarizing plate 206b. On the transparent substrate 205, a color filter and a black matrix BM which are not illustrated are formed, and the counter electrode 204 is disposed as an electrode common to the sub-pixels SPix on a surface located closer to the liquid crystal layer 203 of the transparent substrate 205. The polarizing plate 206b is bonded to a surface of the transparent substrate 205 opposite to the surface where the counter electrode 204 is disposed of the transparent substrate 205. The polarizing plate 206a and the polarizing plate 206b are so bonded as to be arranged in a cross-nicol or parallel-nicol relation to each other.

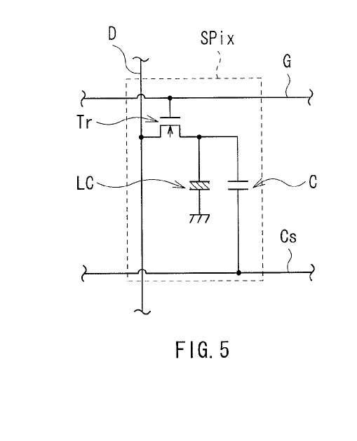

FIG. 5 illustrates an example of a circuit diagram of the sub-pixel SPix. The sub-pixel SPix includes a TFT (Thin Film Transistor) element Tr, a liquid crystal element LC, and a retention capacitor C. The TFT element Tr may be configured of, for example, a MOS-FET (Metal Oxide Semiconductor Field Effect Transistor), and in the TFT element Tr, a gate thereof is connected to a gate line G, a source thereof is connected to a data line D, and a drain thereof is connected to one end of the liquid crystal element LC and one end of the retention capacitor C. In the liquid crystal element LC, the one end thereof is connected to the drain of the TFT element Tr, and the other end thereof is grounded. In the retention capacitor C, the one end thereof is connected to the drain of the TFT element Tr, and the other end thereof is connected to a retention capacitor line Cs. The gate line G is connected to the gate driver 52, and the data line D is connected to the data driver 53.

### (Barrier Section 10)

The barrier section 10 is a so-called parallax barrier, and is configured of an FFS (fringe field switching) mode liquid crystal barrier driving a liquid crystal by a so-called lateral electric field. The barrier section 10 will be described in detail below.

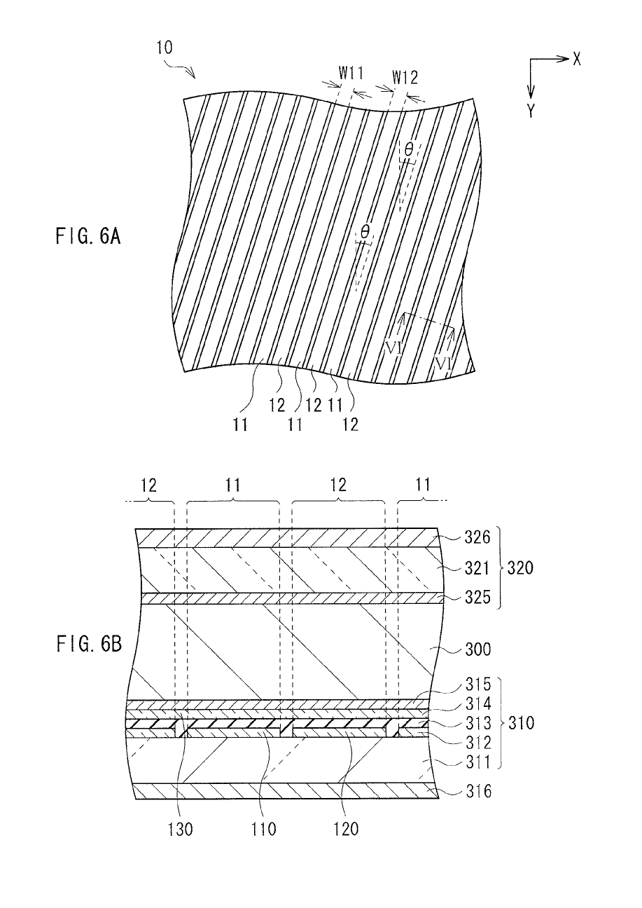

FIGS. 6A and 6B illustrate a configuration example of the barrier section 10. FIG. 6A illustrates a plan view of the barrier section 10, and FIG. 6B illustrates a sectional configuration taken along an arrow line VI-VI in the barrier section 10.

As illustrated in FIG. 6A, the barrier section 10 includes a plurality of opening-closing sections (liquid crystal barriers) 11 and 12 allowing light to pass therethrough or blocking light. The opening-closing sections 11 and 12 are arranged to extend in one direction (in this example, in a direction forming a predetermined angle θ from a vertical direction Y) on an X-Y plane, and are alternately arranged in a horizontal direction X. In this example, a width W11 of each of the opening-closing sections 11 and a width W12 of each of the opening-closing sections 12 are substantially equal to each other, and are substantially equal to a width (a width in the horizontal direction X) of each of the sub-pixels SPix. It is to be noted that a magnitude relation of the widths of the opening-closing sections 11 and 12 are not limited thereto, and the width W11 may be larger than the width W12 (W11>W12) or may be smaller than the width W12 (W11<W12).

As illustrated in FIG. 6B, the barrier section 10 includes a liquid crystal layer 300 between a drive substrate 310 and a counter substrate 320.

The drive substrate 310 includes a transparent substrate 311, a transparent electrode layer 312, an insulating layer 313, a transparent electrode layer 314, an alignment film 315, and a polarizing plate 316. The transparent substrate 311 may be made of, for example, glass. The transparent electrode layer 312 is formed on the transparent substrate 311 with a planarization insulating film (not illustrated) in between. The transparent electrode layer 312 may be configured of, for example, a transparent conductive film made of ITO (Indium Tin Oxide) or the like. Transparent electrodes 110 are formed in regions corresponding to the respective opening-closing sections 11 of the transparent electrode layer 312, and transparent electrodes 120 are formed in regions corresponding to the respective opening-closing sections 12 of the transparent electrode layer 312. The insulating layer 313 is formed on the transparent electrode layer 312. The insulating layer 313 may be made of, for example, SiN or an organic resin. The transparent electrode layer 314 is formed on the insulating layer 313. The transparent electrode layer 314 may be configured of, for example, a transparent conductive film made of ITO or the like, as with the transparent electrode layer 312. A transparent electrode 130 is formed in the entire transparent electrode layer 314. As will be described later, a plurality of slits are formed in the transparent electrode 130. The alignment film 315 is formed on the transparent electrode layer 314. The polarizing plate 316 is bonded to a surface of the drive substrate 310 opposite to a surface where the transparent electrode layers 312 and 314 and the like are formed of the drive substrate 310.

The counter substrate 320 includes a transparent substrate 321, an alignment film 325, and a polarizing plate 326. As with the transparent substrate 311, the transparent substrate 321 may be made of, for example, glass. The alignment film 325 is formed on the transparent substrate 321. The polarizing plate 326 is bonded to a surface of the counter substrate 320 opposite to a surface where the alignment film 325 is formed of the counter substrate 320. The polarizing plate 316 and the polarizing plate 326 are so bonded as to be arranged in a cross-nicol relation to each other. More specifically, for example, a transmission axis of the polarizing plate 316 may be oriented in the horizontal direction X, and a transmission axis of polarizing plate 326 may be oriented in the vertical direction Y.

The liquid crystal layer 300 includes a liquid crystal which is used in this FFS mode, and operates by an electric field in a direction parallel to the drive substrate 310 (a so-called lateral electric field). As the liquid crystal, for example, a liquid crystal with positive dielectric anisotropy (for example, Δ∈=5.2) may be used. The liquid crystal layer 300 performs a normally black operation. In other words, the opening-closing sections 11 and 12 each block light when they are not driven.

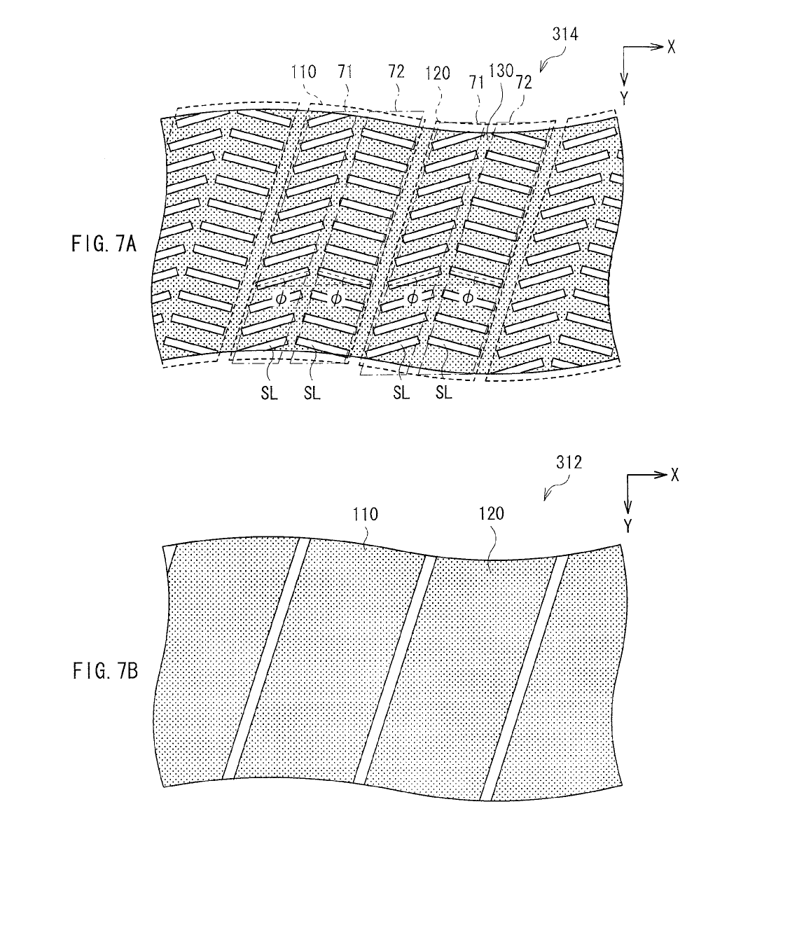

FIGS. 7A and 7B illustrate configuration examples of the transparent electrode layers 312 and 314 in the barrier section 10. FIG. 7A illustrates a configuration example of the transparent electrode 130 in the transparent electrode layer 314, and FIG. 7B illustrates configuration examples of the transparent electrodes 110 and 120 in the transparent electrode layer 312.

As illustrated in FIG. 7A, the transparent electrode 130 is formed in the entire transparent electrode layer 314. Moreover, as illustrated in FIG. 7B, the transparent electrode 110 is formed in a region corresponding to each of the opening-closing sections 11, and the transparent electrode 120 is formed in a region corresponding to each of the opening-closing sections 12 in a like manner. In other words, the transparent electrodes 110 and 120 are so formed as to extend in the same direction as an extending direction of the opening-closing sections 11 and 12.

Slit array regions 71 and 72 arranged side by side in the horizontal direction X are provided to each of regions corresponding to the transparent electrodes 110 of the transparent electrode 130 and each of regions corresponding to the transparent electrodes 120 of the transparent electrode 130. Each of the slit array regions 71 and 72 includes a plurality of slits SL arranged side by side in an extending direction of the transparent electrodes 110 and 120. The slits SL in the slit array region 71 extend in a direction rotated counterclockwise by a predetermined angle φ (for example, 5°) from the horizontal direction X, and the slits SL in the slit array region 72 extend in a direction rotated clockwise by a predetermined angle φ (for example, 5°) from the horizontal direction X. It is to be noted that, in the drawing, the slits SL each have a rectangular shape with four corners, but are not limited thereto. Alternatively, for example, the four corners may be rounded.

In this example, a voltage is selectively applied to the transparent electrodes 110 and 120 of the transparent electrode layer 312, and a common voltage Vcom (for example, 0 V) which is a DC voltage is applied to the transparent electrode 130 of the transparent electrode layer 314.

In such a configuration, in the liquid crystal layer 300 relating to the opening-closing sections 11, a line of electric force is generated between the transparent electrodes 110 and 130 through the slits SL by a potential difference between the transparent electrodes 110 and 130 to generate a lateral electric field in the liquid crystal layer 300. Likewise, in the liquid crystal layer 300 relating to the opening-closing sections 12, a line of electric force is generated between the transparent electrodes 120 and 130 through the slits SL by a potential difference between the transparent electrodes 120 and 130 to generate a lateral electric field. Then, orientation of liquid crystal molecules in the liquid crystal layer 300 is changed in response to the lateral electric field to vary light transmittance in the opening-closing sections 11 and 12. Thus, the opening-closing sections 11 and 12 each perform an open operation and a close operation.

These opening-closing sections 11 and 12 perform different operations depending on whether the stereoscopic display unit 1 performs normal display (two-dimensional display) or stereoscopic display. In other words, as will be described later, the opening-closing sections 11 are turned into an open state (a transmission state) when normal display is performed, and are turned into a close state (a blocking state) when stereoscopic display is performed. On the other hand, as will be described later, the opening-closing sections 12 are turned into an open state (a transmission state) when normal display is performed, and are turned into an open state (a transmission state) in a time-divisional manner when stereoscopic display is performed. More specifically, the opening-closing sections 12 are divided into a plurality of groups, and when stereoscopic display is performed, a plurality of opening-closing sections 12 belonging to a same group perform an open operation and a close operation at same timing. Groups of the opening-closing sections 12 will be described below.

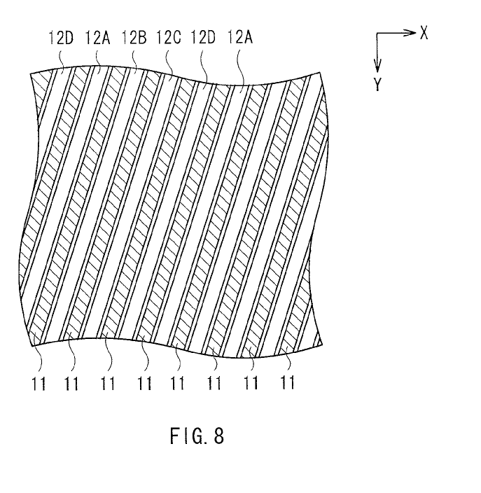

FIG. 8 illustrates a group configuration example of the opening-closing sections 12. In this example, the opening-closing sections 12 are divided into four groups A to D. More specifically, as illustrated in FIG. 8, the opening-closing sections 12 (opening-closing sections 12A) belonging to the group A, the opening-closing sections 12 (opening-closing sections 12B) belonging to the group B, the opening-closing sections 12 (opening-closing sections 12C) belonging to the group C, and the opening-closing section 12 (opening-closing sections 12D) belonging to the group D are alternately arranged in this order.

The barrier drive section 41A drives a plurality of opening-closing sections 12 belonging to a same group to perform the open operation and the close operation at same timing when stereoscopic display is performed. More specifically, as will be described later, a plurality of opening-closing sections 12A belonging to the group A perform an open-and-close operation together, and then, a plurality of opening-closing sections 12B belonging to the group B perform an open-and-close operation together. Next, a plurality of opening-closing sections 12C belonging to the group C perform an open-and-close operation together, and then, a plurality of opening-closing sections 12D belonging to the group D perform an open-and-close operation together. Thus, the barrier drive section 41 alternately drives the opening-closing sections 12A to 12D to perform the open operation and close operation in a time-divisional manner.

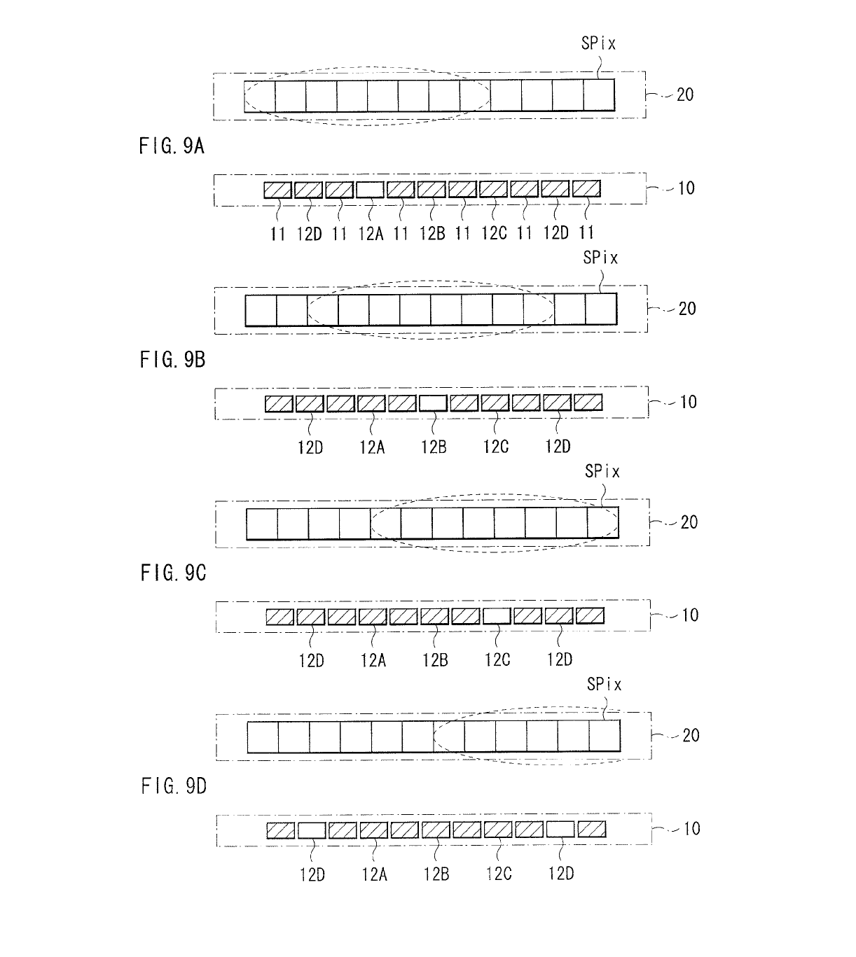

FIGS. 9A to 9D schematically illustrate, with use of sectional configurations, states of the barrier section 10 when stereoscopic display is performed. In this example, one opening-closing section 12A is assigned to eight sub-pixels SPix of the display section 20. Likewise, one opening-closing section 12B is assigned to eight sub-pixels SPix, one opening-closing section 12C is assigned to eight sub-pixels SPix, and one opening-closing section 12D is assigned to eight sub-pixels SPix. It is to be noted that the embodiment of the present disclosure is not limited thereto, and each one of the opening-closing sections 12A, 12B, 12C, and 12D may be assigned to eight pixels Pix instead of eight sub-pixels SPix in the display section 20. In FIGS. 9A to 9D, opening-closing sections blocking light in the opening-closing sections 11 and 12 (12A to 12D) of the barrier section 10 are shaded.

When the stereoscopic display unit 1 performs stereoscopic display, the image signal S3D is supplied to the display drive section 50, and the display section 20 performs display based on the image signal S3D. Then, in the barrier section 10, the opening-closing sections 11 are kept in the close state (the blocking state), and the opening-closing sections 12 (the opening-closing sections 12A to 12D) perform the open operation and the close operation in a time-divisional manner in synchronization with display by the display section 20.

More specifically, in the case where the barrier drive section 41 turns the opening-closing sections 12A into the open state (the transmission state), as illustrated in FIG. 9A, in the display section 20, eight adjacent sub-pixels SPix to which the opening-closing section 12A is assigned display pieces of pixel information P1 to P8 corresponding to eight perspective images. Likewise, in the case where the barrier drive section 41 turns the opening-closing sections 12B into the open state (the transmission state), as illustrated in FIG. 9B, in the display section 20, eight adjacent sub-pixels SPix to which the opening-closing section 12B is assigned display pieces of pixel information P1 to P8 corresponding to eight perspective images. Moreover, in the case where the barrier drive section 41 turns the opening-closing sections 12C into the open state (the transmission state), as illustrated in FIG. 9C, in the display section 20, eight adjacent sub-pixels SPix to which the opening-closing section 12C is assigned display pieces of pixel information P1 to P8 corresponding to eight perspective images. Then, in the case where the barrier drive section 41 turns the opening-closing sections 12D into the open state (the transmission state), as illustrated in FIG. 9D, in the display section 20, eight adjacent sub-pixels SPix to which the opening-closing section 12D is assigned display pieces of pixel information P1 to P8 corresponding to eight perspective images.

Thus, as will be described later, a viewer may see different perspective images with his left and right eyes, thereby perceiving displayed images as a stereoscopic image. In the stereoscopic display unit 1, images are displayed while the opening-closing sections 12A to 12D perform switching between the open state and the close state in a time-divisional manner; therefore, resolution of the display unit is allowed to be enhanced, as will be described later.

It is to be noted that, in the case where normal display (two-dimensional display) is performed, the display section 20 displays a normal two-dimensional image based on the image signal S2D, and in the barrier section 10, all of the opening-closing sections 11 and the opening-closing sections 12 (the opening-closing sections 12A to 12D) are maintained in the open state (in the transmission state). Accordingly, the viewer sees the normal two-dimensional image as it is displayed on the display section 20.

The opening-closing sections 11 and 12 correspond to specific examples of “liquid crystal barriers” in an embodiment of the disclosure. The opening-closing sections 12 correspond to a specific example of “liquid crystal barriers in a first group” in an embodiment of the disclosure, and the opening-closing sections 11 correspond to a specific example of “liquid crystal barriers in a second group” in an embodiment of the disclosure. The transparent electrodes 110 and 120 correspond to specific examples of “first electrodes” in an embodiment of the disclosure, and the transparent electrode 130 corresponds to a specific example of “second electrode” in an embodiment of the disclosure.

### [Operation and Function]

Next, an operation and a function of the stereoscopic display unit 1 according to the embodiment will be described below.

### (Brief Description of Entire Operation)

First, referring to FIG. 1 and the like, an entire operation of the stereoscopic display unit 1 will be briefly described below. The control section 40 controls the backlight drive section 43, the barrier drive section 41, and the display drive section 50 based on the image signal Sdisp externally supplied thereto. The backlight drive section 43 drives the backlight 30 based on the backlight control signal supplied from the control section 40. The backlight 30 emits light toward the barrier section 10 by surface emission. The barrier drive section 41 controls the barrier section 10 based on the barrier control signal supplied from the control section 40. The opening-closing sections 11 and 12 of the barrier section 10 perform the open operation and the close operation based on an instruction from the barrier drive section 41. The display drive section 50 drives the display section 20 based on the image signal Sdisp2 supplied from the control section 40. The display section 20 performs display through modulating light having been emitted from the backlight 30 and having passed through the opening-closing sections 11 and 12 of the barrier section 10.

Next, a specific operation when stereoscopic display is performed will be described below.

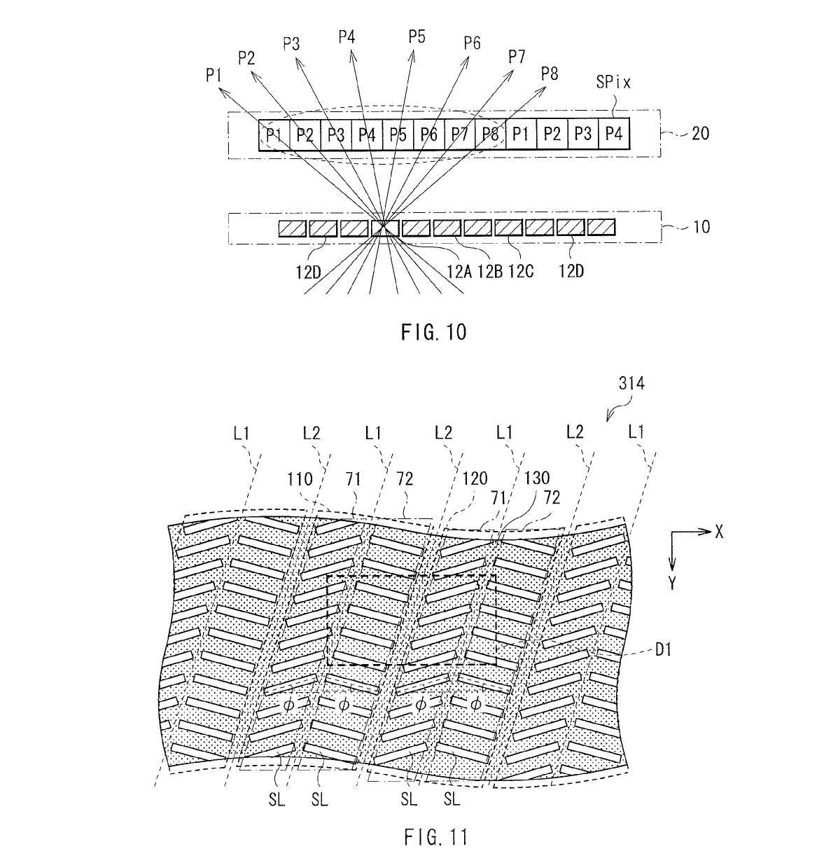

FIG. 10 illustrates operation examples of the display section 20 and the barrier section 10 when the barrier drive section 41 turns the opening-closing sections 12A into the open state (the transmission state). In this case, while the opening-closing section 12A is turned into the open state (the transmission state), the opening-closing sections 12B to 12D are turned into the close state (the blocking state), and sub-pixels SPix disposed around the opening-closing section 12A of the display section 20 display the respective pieces of pixel information P1 to P8 corresponding to eight perspective images included in the image signal S3D. Thus, light rays corresponding to respective pieces of the pixel information P1 to P8 are output with their respective angles limited by the opening-closing section 12A. Accordingly, for example, a viewer viewing from the front of the display screen of the stereoscopic display unit 1 may be allowed to see a stereoscopic image through seeing the pixel information P5 with his left eye and pixel information P4 with his right eye. It is to be noted that, in this case, a case where the barrier drive section 41 turns the opening-closing sections 12A into the open state is described; a similar operation is performed in the case where the opening-closing sections 12B to 12D are turned into the open state.

Thus, the viewer sees different pieces of pixel information from among the pieces of pixel information P1 to P8 with his left eye and his right eye, thereby perceiving such pieces of pixel information as a stereoscopic image. Moreover, since images are displayed while alternately opening and closing the opening-closing sections 12A to 12D in a time-divisional manner, the viewer sees an average of images displayed at positions different from one another. Therefore, the stereoscopic display unit 1 is capable of achieving resolution four times as high as that in the case where only the opening-closing sections 12A are included. In other words, necessary resolution of the stereoscopic display unit 1 is only ½ (=⅛×4) of resolution in the case of two-dimensional display.

### (About Image Quality)

In the stereoscopic display unit 1, the barrier section 10 is configured of an FFS mode liquid crystal barrier. Therefore, as with an FFS mode liquid crystal display unit which is frequently used, and the like, a wide viewing angle is achievable in the stereoscopic display unit 1.

Moreover, in the stereoscopic display unit 1, the transparent electrode 130 in the barrier section 10 includes the slits SL; therefore, a decline in light transmittance in the barrier section 10 is allowed to be suppressed.

FIG. 11 illustrates a boundary between the slit array regions 71 and 72. In this example, for convenience of description, all of the opening-closing sections 11 and 12 are in the open state (the transmission state). Even in this state, liquid crystal alignment in the liquid crystal layer 300 is not sufficient in boundary portions between the mutually-adjacent slit array regions 71 and 72 (around region boundaries L1, and L2); therefore, light does not pass through the boundary portions sufficiently. In other words, the boundary portions become so-called dark lines.

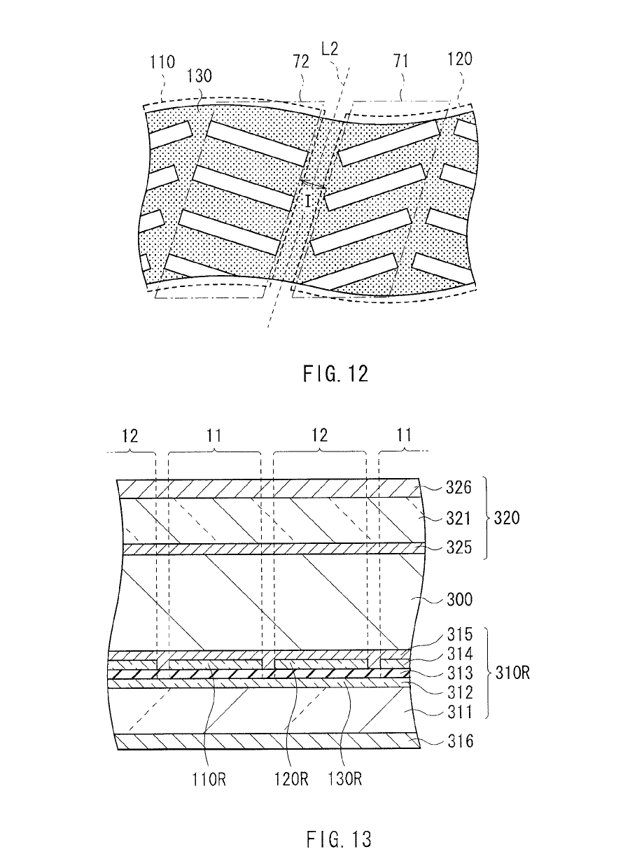

FIG. 12 illustrates an enlarged view of a region D1 of the transparent electrode layer 314 illustrated in FIG. 11. As illustrated in FIG. 12, in the barrier section 10, the slit array region 72 and the slit array region 71 are arranged away from each other at an interval I between the opening-closing sections 11 and 12 (between a region corresponding to the transparent electrode 110 and a region corresponding to the transparent electrode 120). In the barrier section 10, the transparent electrode 130 includes the slits SL; therefore, as will be described later, the interval I is allowed to be narrowed. Accordingly, a width of the dark line in the boundary portion (around the region boundary L2) is allowed to be narrowed, and a decline in light transmittance is allowed to be suppressed.

Moreover, in the stereoscopic display unit 1, the slit array regions 71 and 72 are arranged side by side in the horizontal direction X in the barrier section 10. Therefore, in the stereoscopic display unit 1, moire is allowed to be reduced. In other words, interference between the above-described dark lines at the region boundaries L1 and L2 and the black matrix BM of the display section 20 may cause moire. However, since the slit array regions 71 and 72 are arranged side by side in the horizontal direction X, generation of moire is allowed to be suppressed, as will be described below with use of comparative examples.

Next, functions of the embodiment will be described in comparison with some comparative examples.

### Comparative Example 1

First, a stereoscopic display unit 1R according to Comparative Example 1 will be described below. The stereoscopic display unit 1R is different from the embodiment in the configurations of transparent electrodes in the transparent electrode layers 312 and 314. In other words, in the embodiment (refer to FIGS. 7A and 7B), the transparent electrode layer 312 includes the transparent electrodes 110 and 120 corresponding to the opening-closing sections 11 and 12. Instead, in the comparative example, the transparent electrode layer 314 includes transparent electrodes corresponding to the opening-closing sections 11 and 12. Other configurations are similar to those in this embodiment (refer to FIG. 1).

FIG. 13 illustrates a sectional configuration in a barrier section 10R in Comparative Example 1. The barrier section 10R includes a drive substrate 310R. In the drive substrate 310R, a transparent electrode 130R is formed in the entire transparent electrode layer 312. Moreover, transparent electrodes 110R are formed in regions corresponding to the respective opening-closing sections 11 of the transparent electrode layer 314, and transparent electrodes 120R are formed in regions corresponding to the respective opening-closing sections 12 of the transparent electrode layer 314. As will be described later, a plurality of slits SL are formed in the transparent electrodes 110R and 120R.

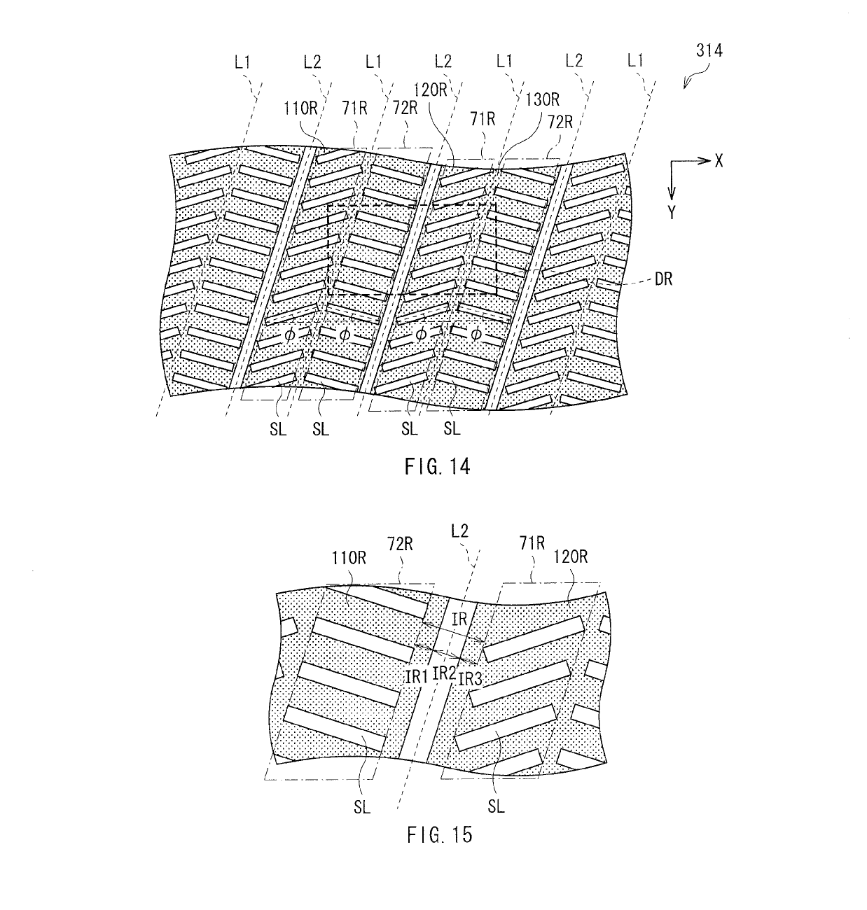

FIG. 14 illustrates a configuration example of the transparent electrode layer 314 of the barrier section 10R. Slit array regions 71R and 72R arranged side by side in the horizontal direction X are provided to each of the transparent electrodes 110R and 120R, and each of the slit array regions 71R and 72R includes a plurality of slits SL arranged side by side in an extending direction of the transparent electrodes 110R and 120R. The common voltage Vcom (for example, 0 V) which is a DC voltage is applied to the transparent electrode 130R of the transparent electrode layer 312, and a voltage is selectively applied to the transparent electrodes 110R and 120R of the transparent electrode layer 314.

FIG. 15 illustrates an enlarged view of a region DR of the transparent electrode layer 314 illustrated in FIG. 14. As illustrated in FIG. 15, in the barrier section 10R, the slit array region 72R and the slit array region 71R are arranged away from each other at an interval IR between the opening-closing sections 11 and 12 (between the transparent electrodes 110R and 120R). The interval IR is configured of three intervals IR1, IR2, and IR3. In other words, the interval IR1 is an interval between a right edge of the slit array region 72R and a right edge of the transparent electrode 110R in the transparent electrode 110R, and the interval IR3 is an interval between a left edge of the slit array region 71R and a left edge of the transparent electrode 120R in the transparent electrode 120R. Moreover, the interval IR2 is an interval between the transparent electrode 110R and the transparent electrode 120R. Minimum values of these intervals IR1 to IR3 are determined by design rules. More specifically, the minimum values of the intervals IR1 and IR3 are limited by a minimum value of a line width in the transparent electrode layer 314, and the minimum value of the interval IR2 is limited by a minimum value of a space in the transparent electrode layer 314. Accordingly, a minimum value of the interval IR (IR1+IR2+IR3) is limited by these three design rules; therefore, the interval IR may not be sufficiently narrowed. For example, when the minimum value of the line width and the minimum value of the space in the transparent electrode layer 314 are substantially equal to each other, the interval IR is about three times as large as the interval IR2 between the transparent electrodes 110R and 120R. In this case, a width of a dark line in this region (around the region boundary L2) is increased, thereby resulting in a decline in light transmittance.

On the other hand, in the barrier section 10 according to the embodiment, since the transparent electrode 130 of the transparent electrode layer 314 includes the slits SL, the interval I between the slit array region 72 and the slit array region 71 is allowed to be reduced. In other words, since the transparent electrode 130 is formed in the entire transparent electrode layer 314, the interval I is limited only by the minimum value of the line width in the transparent electrode layer 314. For example, when the minimum value of the line width and the minimum value of the space in the transparent electrode layers 312 and 314 are substantially equal to each other, the interval I is allowed to be substantially equal to an interval between the transparent electrodes 110 and 120. In other words, in the barrier section 10, the interval I is allowed to become smaller than the interval IR according to the comparative example. Accordingly, the width of the dark line in this region (around the region boundary L2) is allowed to be narrowed, and a decline in light transmittance is allowed to be suppressed.

Moreover, in the case where the width of the dark line at the region boundary L2 is narrowed to become substantially equal to a width of the dark line at the region boundary L1, as will be described later, possibility of generation of moire is allowed to be reduced.

### Comparative Example 2

Next, a stereoscopic display unit 1S according to Comparative Example 2 will be described below. The stereoscopic display unit 1S is different from the embodiment in arrangement of the slit array regions in the transparent electrode layer 314. In other words, while, in the embodiment (refer to FIGS. 7A and 7B), the slit array regions 71 an 72 are arranged side by side in the horizontal direction X in the transparent electrode layer 314, in the comparative example, slit array regions are arranged side by side in an extending direction of transparent electrodes. Other configurations are similar to those in the embodiment (refer to FIG. 1).

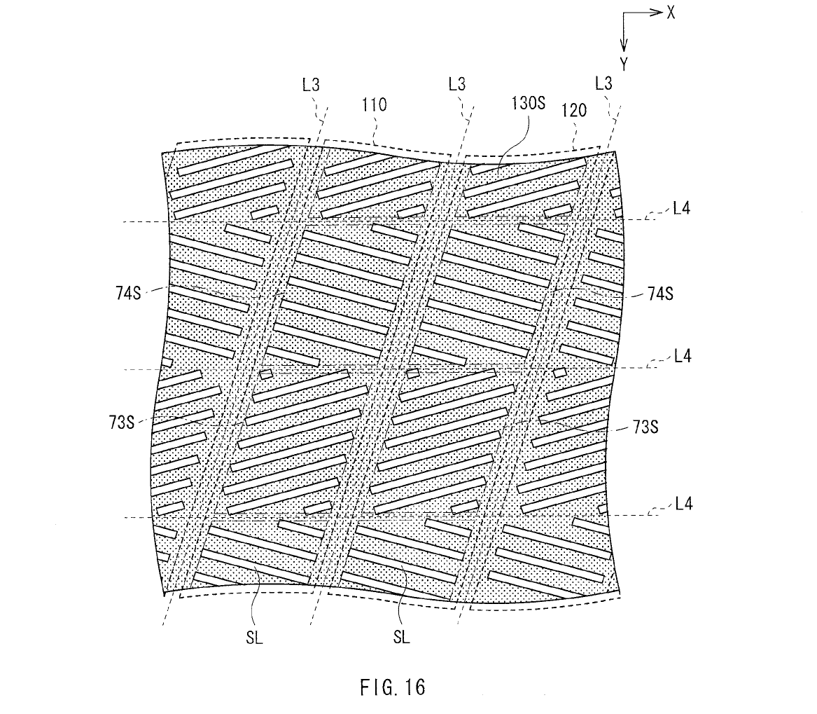

FIG. 16 illustrates a configuration example of the transparent electrode layer 314 in a barrier section 10S in Comparative Example 2. As illustrated in FIG. 16, a transparent electrode 130S is formed in the entire transparent electrode layer 314. In the transparent electrode 130S, slit array regions 73S and 74S alternately arranged side by side in an extending direction of the transparent electrodes 110 and 120 are provided to each of regions corresponding to the transparent electrodes 110 of the transparent electrode 130S and each of regions corresponding to the transparent electrodes 120 of the transparent electrode 130S. The slits SL in the slit array region 73S extend in a direction rotated counterclockwise by a predetermined angle (for example, 5°) from the horizontal direction X, and the slits SL in the slit array region 74S extend in a direction rotated clockwise by a predetermined angle (for example, 5°) from the horizontal direction X.

Also in this example, liquid crystal alignment in the liquid crystal layer 300 is not sufficient in boundary portions (around region boundaries L3) between the slit array regions 73S and 74S adjacent to each other in the horizontal direction X and in boundary portions (around the region boundaries L4) between the slit array regions 73S and 74S adjacent to each other in the extending direction of the transparent electrodes 110 and 120; therefore, light does not pass through the boundary portions sufficiently, and the boundary portions become so-called dark lines. In other words, in the barrier section 10S, unlike the case of the barrier section 10 according to the above-described embodiment (refer to FIG. 11), in addition to the region boundaries L3 extending in the extending direction of the transparent electrodes 110 and 120, the region boundaries L4 extending in the horizontal direction X also become dark lines.

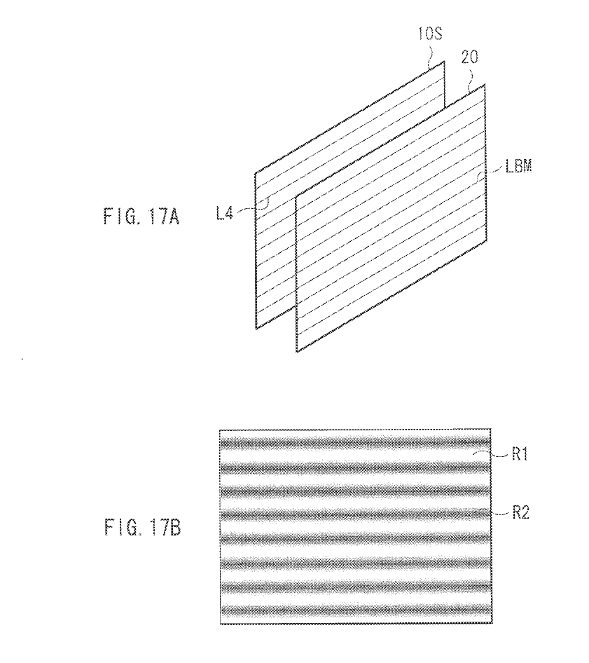

FIG. 17A illustrates a relative relationship between the black matrix BM of the display section 20 and the region boundaries of the barrier section 10S, and FIG. 17B illustrates moire appearing on the display screen. In FIGS. 17A and 17B, for convenience of description, only black matrix portions (light-blocking lines LBM) extending in the horizontal direction X in the black matrix BM in the display section 20 are illustrated, and only the region boundaries L4 extending in the horizontal direction X of the region boundaries in the barrier section 10S are illustrated.

As illustrated in FIG. 17A, both the light-blocking lines LBM of the display section 20 and the region boundaries L4 of the barrier section 10S extend in the horizontal direction X in the display screen of the stereoscopic display unit 1S. Moreover, as illustrated in FIGS. 2A and 2B, the display section 20 and the barrier section 10R are arranged side by side in a depth direction when the viewer sees the stereoscopic display unit 1S. Therefore, a shift between periodic positions of the light-blocking lines LBM and periodic positions of the region boundaries L4 may occur in the vertical direction Y, depending on a positional relationship between the stereoscopic display unit 1S and the viewer, and the viewer may see moire as illustrated in FIG. 17B. More specifically, for example, a display screen region where the region boundary L4 and the light-blocking line LBM are substantially superimposed on each other becomes a bright section R1, and a display screen region where the region boundary L4 and the light-blocking line LBM are largely shifted from each other becomes a dark section R2. Thus, the viewer perceives a difference in luminance between the bright section R1 and the dark section R2 as moire.

It is to be noted that, in this example, moire caused by the light-blocking lines LBM of the display section 20 and the region boundaries L4 of the barrier section 10S is described; however, for example, moire may be caused by lines extending in the vertical direction Y in the black matrix BM in the display section 20 and the region boundaries L3 of the barrier section 10S.

Thus, in the stereoscopic display unit 1S according to Comparative Example 2, as illustrated in FIG. 16, since the slit array regions 73S and 74S are alternately arranged side by side in the extending direction of the transparent electrodes 110 and 120, the region boundaries L4 extending in the horizontal direction X are produced; therefore, interference between the region boundaries L4 and the light-blocking lines LBM extending in the horizontal direction X of the display section 20 causes moire.

On the other hand, in the stereoscopic display unit 1 according to the embodiment, as illustrated in FIGS. 7A and 7B, the slit array regions 71 and 72 are arranged side by side in the horizontal direction X. Therefore, only the region boundaries L1 and L2 extending in the extending direction of the transparent electrodes 110 and 120 are formed, and formation of region boundaries extending in the horizontal direction X is avoidable. Moreover, unlike Comparative Example 2 (refer to FIG. 16), the region boundary L1 is formed in the middle of each of the transparent electrodes 110 and 120 (refer to FIG. 11). Accordingly, in the case where the width of each of the dark lines at the region boundaries L2 is reduced to be substantially equal to the width of each of the dark lines at the region boundaries L1, line density of dark lines with a substantially equal width is allowed to be increased; therefore, possibility of generation of moire is allowed to be reduced.

### [Effects]

As described above, in the embodiment, since the barrier section is configured of an FFS mode liquid crystal barrier, a wide viewing angle is achievable, and image quality is allowed to be enhanced.

Moreover, in the embodiment, the transparent electrode 130 is formed in the entire transparent electrode layer 314, and the transparent electrode 130 includes the slits; therefore, intervals between the slit array regions are allowed to be reduced. Accordingly, a decline in light transmittance is allowed to be suppressed, thereby enhancing image quality.

Further, in the embodiment, since the slit array regions are arranged side by side in the horizontal direction in each transparent electrode, possibility of generation of moire is allowed to be reduced, and image quality is allowed to be enhanced accordingly.

### [Modification 1-1]

In the above-described embodiment, the width of each of the opening-closing sections 11 and the width of each of the opening-closing sections 12 are substantially equal to each other, but the widths are not limited thereto. A case where the width of each of the opening-closing sections 11 is about twice as large as the width of each of the opening-closing sections 12 will be described below.

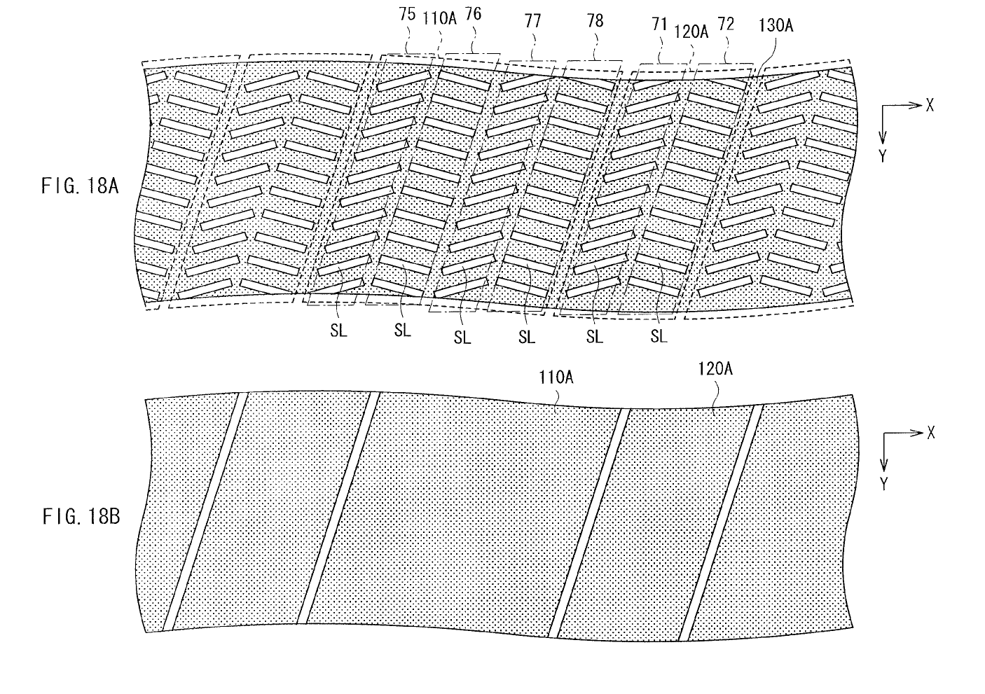

FIG. 18A illustrates a configuration example of a transparent electrode 130A in a barrier section 10A according to a modification, and FIG. 14B illustrates configuration examples of transparent electrodes 110A and 120A. The transparent electrode 110A is formed in each of regions corresponding to the opening-closing sections 11, and the transparent electrode 120 is formed in each of regions corresponding to the opening-closing sections 12. Four slit array regions 75 to 78 arranged side by side in the horizontal direction X are provided to a region corresponding to the transparent electrode 110A of the transparent electrode 130, and two slit array regions 71 and 72 arranged side by side in the horizontal direction X are provided to a region corresponding to the transparent electrode 120A of the transparent electrode 130A. In this example, widths in the horizontal direction X of the slit array regions 71, 72, and 75 to 78 are substantially equal to one another. Also in this case, image quality is allowed to be enhanced.

### [Modification 1-2]

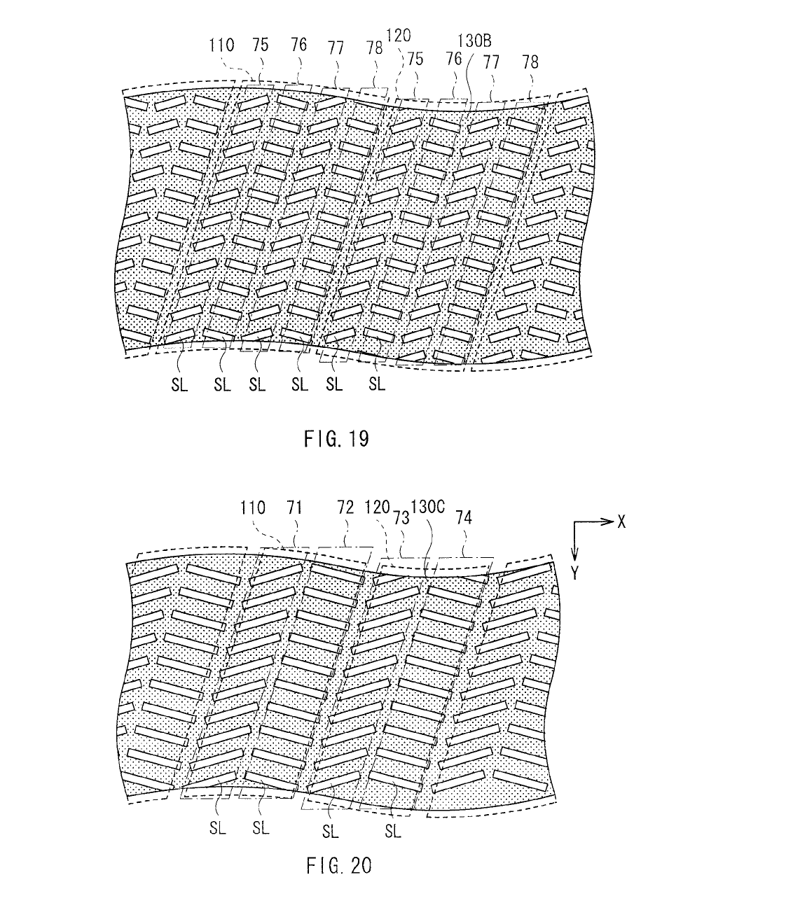

In the above-described embodiment, two slit array regions 71 and 72 are provided to each of regions corresponding to the transparent electrodes 110 of the transparent electrode 130 and each of regions corresponding to the transparent electrodes 120 of the transparent electrode 130; however, the number of slit array regions is not limited to two. Alternatively, for example, as illustrated in FIG. 19, three or more slit array regions may be provided to each of regions corresponding to the transparent electrodes 110 of a transparent electrode 130B and each of regions corresponding to the transparent electrodes 120 of the transparent electrode 130B. In this example, four slit array regions 74 to 78 are provided to each of the regions corresponding to the transparent electrodes 110 and 120 of the transparent electrode layer 130B. It is to be noted that, in terms of symmetry of viewing angle, an even number of slit array regions having slits SL oriented in directions different from one another are preferably provided.

### [Modification 1-3]

In the above-described embodiment, the slits SL belonging to each of two slit array regions 71 and 72 are so arranged as to fit in each of regions corresponding to the transparent electrodes 110 of the transparent electrode 130 and each of regions corresponding to the transparent electrodes 120 of the transparent electrode 130; however, the arrangement of the slits SL is not limited thereto. Alternatively, for example, as illustrated in FIG. 20, the slits SL may be so arranged as to protrude from each of regions corresponding to the transparent electrodes 110 of a transparent electrode 130C and each of regions corresponding to the transparent electrodes 120 of the transparent electrode 130C.

### 2. APPLICATION EXAMPLES

Next, application examples of the stereoscopic display units described in the above-described embodiment and the modifications thereof will be described below.

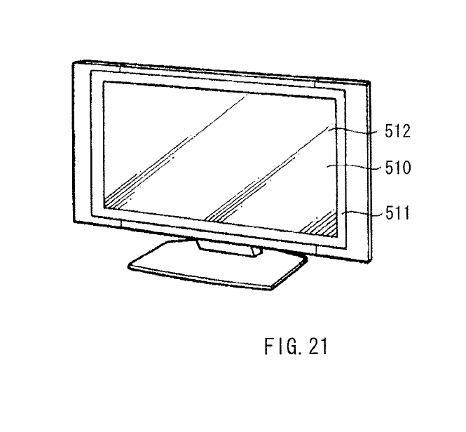

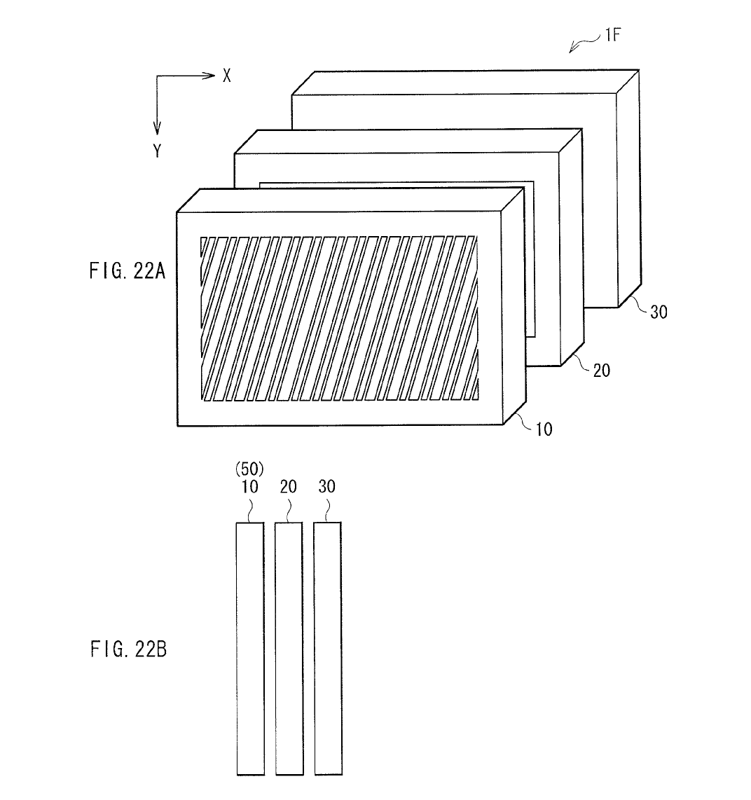

FIG. 21 illustrates an appearance of a television to which any one of the stereoscopic display units according to the above-described embodiment and the like is applied. The television may include, for example, an image display screen section 510 including a front panel 511 and a filter glass 512. The image display screen section 510 is configured of any one of the stereoscopic display units according to the above-described embodiments and the like.

The stereoscopic display units according to the above-described embodiment and the like are applicable to, in addition to such a television, electronic apparatuses in any fields, including digital cameras, notebook personal computers, portable terminal devices such as cellular phones, portable game machines, and video cameras. In other words, the stereoscopic display units according to the above-described embodiments and the like are applicable to electronic apparatuses in any fields displaying an image.

Although the technology of the present disclosure is described referring to some embodiments, the modifications, and the application examples to electronic apparatuses, the technology is not limited thereto, and may be variously modified.

For example, in the above-described embodiment and the like, the backlight 30, the barrier section 10, and the display section 20 in each of the stereoscopic display units 1 are arranged in this order; however, the arrangement order of them is not limited thereto. Alternatively, as illustrated in FIG. 22, the backlight 30, the display section 20, and the barrier section 10 may be arranged in this order.

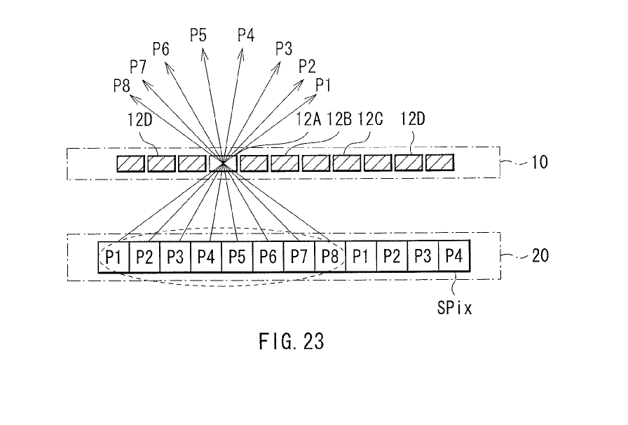

FIG. 23 illustrates operation examples of the display section 20 and the barrier section 10 according to this modification. This example provides operation examples of the display section 20 and the barrier section 10 in the case where the barrier drive section 41 turns the opening-closing sections 12A into the open state (the transmission state). In this modification, light emitted from the backlight 30 first enters the display section 20, and then enters the barrier section 10. Also in this case, light rays corresponding to the respective pixel information P1 to P8 are output with their respective angles limited by the opening-closing section 12A.

Moreover, for example, in the above-described embodiment and the like, the opening-closing sections 12 are divided into four groups; however, the number of groups is not limited thereto, and the opening-closing sections 12 may be divided into three or less groups, or five or more groups. Moreover, the opening-closing sections 12 may not be divided into groups. In this case, the opening-closing sections are constantly in the open state (the transmission state) during stereoscopic display.

Further, for example, in the above-described embodiment and the like, eight perspective images are displayed during stereoscopic display; however, the number of perspective images to be displayed is not limited thereto, and seven or less perspective images or nine or more perspective images may be displayed. In this case, a relative positional relationship between the opening-closing sections 12A to 12D of the barrier section 10 and the sub-pixels SPix illustrated in FIGS. 9A to 9D is also varied. More specifically, for example, in the case where nine perspective images are displayed, each one of the opening-closing sections 12A to 12D may be assigned to nine sub-pixels SPix in the display section 20.

Moreover, for example, in the above-described embodiment and the like, the display section 20 is a liquid crystal display section; however, the display section 20 is not limited thereto. Alternatively, the display section 20 may be, for example, an EL (electroluminescence) display section using organic EL. In this case, for example, a configuration illustrated in FIG. 22 without the backlight 30 may be used.

It is to be noted that the technology is allowed to have the following configurations.

(1) A display unit including:

a display section displaying an image; and

a barrier section including a plurality of liquid crystal barriers, the light crystal barriers allowing light to pass therethrough and blocking the light, and extending in a first direction and being arranged side by side in a second direction that is orthogonal to the first direction,

in which the barrier section includes

a liquid crystal layer,

first electrodes disposed in regions corresponding to the respective liquid crystal barriers, and

a second electrode disposed between the first electrodes and the liquid crystal layer and disposed to face and be common to the first electrodes,

the second electrode includes a plurality of slit array regions arranged side by side in the second direction, and

each of the slit array regions includes a plurality of slits provided side by side, the slits in any one of the slit array regions extending in a same direction.

(2) The display unit according to (1), in which each of the first electrodes is formed in a region corresponding to a predetermined number of the slit array regions adjacent to one another.

(3) The display unit according to (2), in which an interval between the slit array regions adjacent to each other in the second direction is smaller than about three times an interval between the first electrodes adjacent to each other in the second direction.

(4) The display unit according to (2) or (3), in which slits of the plurality of slits belonging to the predetermined number of slit array regions are formed in a region corresponding to the corresponding first electrode.

(5) The display unit according to (2) or (3), in which slits of the plurality of slits belonging to the predetermined number of slit array regions each protrude partially from a region corresponding to the corresponding first electrode.

(6) The display unit according to any one of (2) to (5), in which the predetermined number is an even number.

(7) The display unit according to any one of (1) to (6), in which slits of the plurality of slits belonging to a first slit array region of the plurality of slit array regions extend in a direction different from a direction in which slits of the plurality of slits belonging to a second slit array region of the plurality of slit array regions extend, the second slit array region being adjacent to the first slit array region.

(8) The display unit according to any one of (1) to (7), in which

barrier drive signals are applied to the respective first electrodes, and

a direct-current voltage is applied to the second electrode.

(9) The display unit according to any one of (1) to (8), in which

the display section is a liquid crystal display section, and

the barrier crystal barriers include a plurality of liquid crystal barriers in a first group and a plurality of liquid crystal barriers in a second group.

(10) The display unit according to (9), in which

the display unit has a plurality of display modes including a first display mode and a second display mode,

in the first display mode, the liquid crystal display section displays a plurality of perspective images, and the barrier section operates to turn the liquid crystal barriers in the first group into a transmission state and to turn the liquid crystal barriers in the second group into a blocking state, thereby allowing light rays from or toward the respective perspective images to be oriented in respective angle directions limited corresponding to the respective light rays, and

in the second display mode, the liquid crystal display section displays a single perspective image, and the barrier section operates to turn the liquid crystal barriers in the first group and the liquid crystal barriers in the second group into a transmission state, thereby allowing light rays from or toward the single perspective image to pass therethrough.

(11) The display unit according to (10), in which

the liquid crystal barriers in the first group are divided into a plurality of barrier sub-groups, and

in the first display mode, the liquid crystal barriers in the first group are switched between the transmission state and the blocking state in a time-divisional manner for each of the barrier sub-groups.

(12) The display unit according to any one of (1) to (11), further including a backlight,

in which the display section is a liquid crystal display section, and

the barrier section is disposed between the backlight and the liquid crystal display section.

(13) The display unit according to any one of (1) to (11), further including a backlight,

in which the display section is a liquid crystal display section, and

the liquid crystal display section is disposed between the backlight and the barrier section.

(14) A barrier device including:

a barrier section including a plurality of liquid crystal barriers, the liquid crystal barriers allowing light to pass therethrough and blocking the light, and extending in a first direction and being arranged side by side in a second direction that is orthogonal to the first direction,

in which the barrier section includes

a liquid crystal layer,

first electrodes disposed in regions corresponding to the respective liquid crystal barriers, and

a second electrode disposed between the first electrodes and the liquid crystal layer and disposed to face and be common to the first electrodes,

the second electrode includes a plurality of slit array regions arranged side by side in the second direction, and

each of the slit array regions includes a plurality of slits provided side by side, the slits in any one of the slit array regions extending in a same direction.

(15) An electronic apparatus provided with a display unit and a control section which performs operation control with use of the display unit, the display unit including:

a display section displaying an image; and

a barrier section including a plurality of liquid crystal barriers, the light crystal barriers allowing light to pass therethrough and blocking the light, and extending in a first direction and being arranged side by side in a second direction that is orthogonal to the first direction,

in which the barrier section includes

a liquid crystal layer,

first electrodes disposed in regions corresponding to the respective liquid crystal barriers, and

a second electrode disposed between the first electrodes and the liquid crystal layer and disposed to face and be common to the first electrodes,

the second electrode includes a plurality of slit array regions arranged side by side in the second direction, and

each of the slit array regions includes a plurality of slits provided side by side, the slits in any one of the slit array regions extending in a same direction.

The present disclosure contains subject matter related to that disclosed in Japanese Priority Patent Application No. 2012-107894 filed in the Japan Patent Office on May 9, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section displaying an image; and
a barrier section including a plurality of liquid crystal barriers, the light crystal barriers allowing light to pass therethrough and blocking the light, and extending in a first direction and being arranged side by side in a second direction that is orthogonal to the first direction,
wherein the barrier section includes
a liquid crystal layer,
first electrodes disposed in regions corresponding to the respective liquid crystal barriers, and
a second electrode disposed between the first electrodes and the liquid crystal layer and disposed to face and be common to the first electrodes,
the second electrode includes a plurality of slit array regions arranged side by side in the second direction, and
each of the slit array regions includes a plurality of slits provided side by side, the slits in any one of the slit array regions extending in a same direction.

2. The display unit according to claim 1, wherein each of the first electrodes is formed in a region corresponding to a predetermined number of the slit array regions adjacent to one another.

3. The display unit according to claim 2, wherein an interval between the slit array regions adjacent to each other in the second direction is smaller than about three times an interval between the first electrodes adjacent to each other in the second direction.

4. The display unit according to claim 2, wherein slits of the plurality of slits belonging to the predetermined number of slit array regions are formed in a region corresponding to the corresponding first electrode.

5. The display unit according to claim 2, wherein slits of the plurality of slits belonging to the predetermined number of slit array regions each protrude partially from a region corresponding to the corresponding first electrode.

6. The display unit according to claim 2, wherein the predetermined number is an even number.

7. The display unit according to claim 1, wherein slits of the plurality of slits belonging to a first slit array region of the plurality of slit array regions extend in a direction different from a direction in which slits of the plurality of slits belonging to a second slit array region of the plurality of slit array regions extend, the second slit array region being adjacent to the first slit array region.

8. The display unit according to claim 1, wherein
barrier drive signals are applied to the respective first electrodes, and
a direct-current voltage is applied to the second electrode.

9. The display unit according to claim 1, wherein
the display section is a liquid crystal display section, and
the barrier crystal barriers include a plurality of liquid crystal barriers in a first group and a plurality of liquid crystal barriers in a second group.

10. The display unit according to claim 9, wherein
the display unit has a plurality of display modes including a first display mode and a second display mode,
in the first display mode, the liquid crystal display section displays a plurality of perspective images, and the barrier section operates to turn the liquid crystal barriers in the first group into a transmission state and to turn the liquid crystal barriers in the second group into a blocking state, thereby allowing light rays from or toward the respective perspective images to be oriented in respective angle directions limited corresponding to the respective light rays, and
in the second display mode, the liquid crystal display section displays a single perspective image, and the barrier section operates to turn the liquid crystal barriers in the first group and the liquid crystal barriers in the second group into a transmission state, thereby allowing light rays from or toward the single perspective image to pass therethrough.

11. The display unit according to 10, wherein
the liquid crystal barriers in the first group are divided into a plurality of barrier sub-groups, and
in the first display mode, the liquid crystal barriers in the first group are switched between the transmission state and the blocking state in a time-divisional manner for each of the barrier sub-groups.

12. The display unit according to claim 1, further comprising a backlight,
wherein the display section is a liquid crystal display section, and
the barrier section is disposed between the backlight and the liquid crystal display section.

13. The display unit according to claim 1, further comprising a backlight,
wherein the display section is a liquid crystal display section, and
the liquid crystal display section is disposed between the backlight and the barrier section.

14. A barrier device comprising:
a barrier section including a plurality of liquid crystal barriers, the liquid crystal barriers allowing light to pass therethrough and blocking the light, and extending in a first direction and being arranged side by side in a second direction that is orthogonal to the first direction,
wherein the barrier section includes
a liquid crystal layer,
first electrodes disposed in regions corresponding to the respective liquid crystal barriers, and
a second electrode disposed between the first electrodes and the liquid crystal layer and disposed to face and be common to the first electrodes,
the second electrode includes a plurality of slit array regions arranged side by side in the second direction, and
each of the slit array regions includes a plurality of slits provided side by side, the slits in any one of the slit array regions extending in a same direction.

15. An electronic apparatus provided with a display unit and a control section which performs operation control with use of the display unit, the display unit comprising:
a display section displaying an image; and
a barrier section including a plurality of liquid crystal barriers, the light crystal barriers allowing light to pass therethrough and blocking the light, and extending in a first direction and being arranged side by side in a second direction that is orthogonal to the first direction,
wherein the barrier section includes
a liquid crystal layer,
first electrodes disposed in regions corresponding to the respective liquid crystal barriers, and
a second electrode disposed between the first electrodes and the liquid crystal layer and disposed to face and be common to the first electrodes,
the second electrode includes a plurality of slit array regions arranged side by side in the second direction, and
each of the slit array regions includes a plurality of slits provided side by side, the slits in any one of the slit array regions extending in a same direction.
